(19) United States
(12) Patent Application Publication
(10) Pub. No.: US 2015/0034040 A1
(43) Pub. Date: Feb. 5, 2015

(54) FOAM PART WITH IN-MOLDED GROMMET AND METHOD OF MAKING THE SAME

(71) Applicant: Eagle Industries, Inc., Wixom, MI (US)

(72) Inventor: Keith J. Byer, West Bloomfield, MI (US)

(21) Appl. No.: 13/956,095

(22) Filed: Jul. 31, 2013

(51) Int. Cl. F16B 5/02; B29C 70/68; F16F 1/373; B29C 70/70

(52) U.S. Cl. CPC F16B 5/0258; B29C 70/70; B29C 70/682; F16F 1/3732; B29L 2009/005
USPC 123/195 C; 264/46.9; 16/2.1

(57) ABSTRACT

A part with an in-molded grommet and a process of making the same. The part includes a core of cured foam; and a grommet with a flange opposite a rim. The flange is surrounded by the core and the rim and/or an adjacent tapered section of the grommet are not covered by the foam. The process of making the part, which is preferably a single piece, includes inserting a grommet with a flange into the tool, dispensing foam into the tool, allowing the foam to expand around the flange of the grommet and to cure; and extracting a part with an in-molded grommet with the tapered section substantially uncoated by foam.

### CROSS-REFERENCE TO RELATED APPLICATION

This application claims priority to U.S. provisional application No. 61/680,416, filed on Aug. 7, 2012, the contents of which are incorporated herein by reference in its entirety.

### FIELD OF THE DISCLOSURE

This disclosure relates to a foam part with an in-molded grommet and a process of making the same. More specifically, the part and the process include a foam part with a grommet molded with cured foam securing the grommet in the part.

### BACKGROUND

A variety of parts use grommets to attach, fasten, or connect the part to a larger product. Such a part includes plastic engine covers with an open-end hard plastic housing into which a rubber grommet can be inserted, such as by sliding into the housing. Plastic covers can be fitted with grommets, but this adds additional steps and multiple parts in assembly. Ball-stud anchoring grommets are known.

Molded foam parts have been taking the place of hard plastic parts to provide improved appearance, weight benefits and other improved characteristics for many applications.

U.S. Pat. No. 8,205,592 discloses an engine cover and a method of making the same with a textured surface with an in-mold coating. A noise abatement cover for an engine has a textured, in-mold coated, high quality outer appearance with a core of medium density polyurethane. The method of making the cover includes applying a mold release to grained aluminum tool and applying coating to at least one side of the grained aluminum tool to form an in-mold coating on the resulting engine cover.

U.S. Pat. No. 8,205,592 further discloses an attachment element 36 that can be used as an attachment feature to secure the engine cover to an engine. An end of the attachment element 36 may be molded into the engine cover. That element with other apertures worked well to secure the engine cover to an engine. But other means of attaching a part are desired

### SUMMARY

The present disclosure provides a molded foam part that includes an in-molded grommet. The preferred part provides a grommet permanently secured in the part, such as a cover used for the top of an engine or a fuel pump. The construction of the part is different from earlier parts by combining a unique grommet molded in an integral part.

The process used to make a foam part with an in-molded grommet is important to obtain an acceptable part. The preferred process of making such a part includes:

inserting into a molding tool a grommet, such as a ball-stud anchoring grommet with a flange, which is preferably tilted with a tip of the grommet up;

dispensing foam, such as polyurethane, into the tool;

allowing foam to expand in a tool cavity around a base of the grommet and to cure; and

extracting a part with an in-molded grommet from the tool.

Tilting the tool and grommet inside may assist in venting air to avoid air being trapped that otherwise may adversely affect the final part.

The preferred process results in a part with a grommet secured by internal foam without voids due to trapped air.

### BRIEF DESCRIPTION OF THE DRAWINGS

The above-mentioned and other features of this disclosure and the manner of obtaining them will become more apparent, and the disclosure itself will be best understood by reference to the following descriptions of parts and processes taken in conjunction with the accompanying figures, which are given as non-limiting examples only, in which:

FIG. 1 shows a perspective view of a portion of a part with an in-molded grommet;

FIG. 2 shows a perspective view of a grommet with a flange; and

FIG. 3 shows a cross sectional view of the grommet.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

### The Grommet and the Part

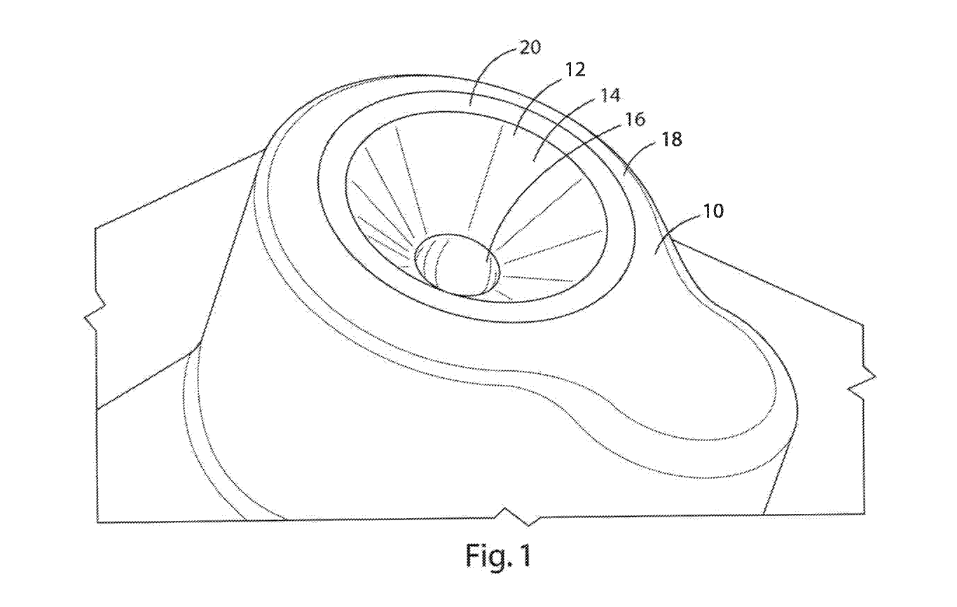

As shown in FIG. 1, a part 10 includes a grommet 12 with an exposed tapered section 14 and a preferred ball stud receptacle 16. As such, the grommet 12 can be a ball stud anchoring grommet with the tapered section 14 within a rim 20 and the ball stud receptacle 16, which are not covered by foam in the part 10. The rim 20 is sometimes not covered, by the cured foam, but the tapered section 14 of the grommet 12 is the key component to not have a foam coating. The part 10 is preferably a single, integral piece with the edge 18 of the part 10 aligned with and secured to the rim 20 of the grommet 12. The core of the part 10 is cured foam.

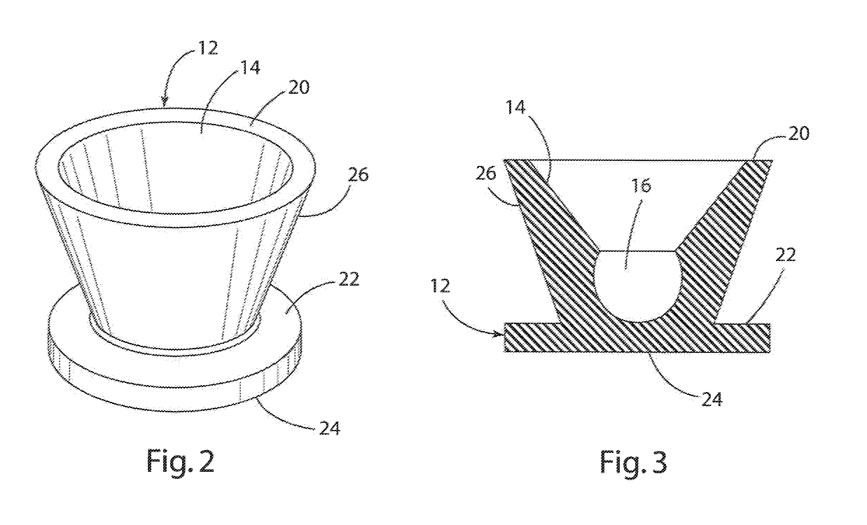

The grommet 12 preferably has a flange 22 to help secure the grommet 12 into the part 10. The flange 22 as shown in FIGS. 2 and 3 preferably extends from a base end 24 opposite the rim 20, and the flange 22 may include apertures, irregular shapes or rough surfaces to allow foam to flow into or around such apertures, irregular or asymmetrical shapes or rough surfaces. The flange 22 and the base end 24 are preferably completely surrounded by foam in the part 10 to secure the grommet 12 in place.

An outer wall 26 of the grommet 12 forms an opposing wall with the tapered section 14 (as the inner wall) also tapers or narrows inward toward the flange 22 wherein the flange 22 forms a lip, and the space between the flange 22 and outer wall 26 of the grommet 12 can fill with foam during the molding process to firmly secure the grommet 12 within the part 10.

The grommet 12 may be specially formulated rubber so that the foam properly adheres to the grommet 12 during and after molding. A component is removed from typical rubber for better adhesion by foam.

The grommet 12 itself may serve as attachment element to secure the part 10 to any larger product, such as an engine cover to an engine, such as via a ball stud fastener. The attachment properties of the grommet 12 can also be used within the tool having a fastener securing the grommet 12 during the molding process.

### The Process

The process of making the part 10 with an in-molded grommet 12 includes several steps. The preferred process of making a part 10 with a grommet 12 may include:

inserting into the tool a grommet 12, such as a ball-stud anchoring grommet with a flange 22, which is preferably tilted with a tip of the grommet 12 up;

dispensing foam, such as polyurethane, into the tool;

allowing foam to expand in a tool cavity around a base end 24 of the grommet 12 and to cure; and

extracting a part 10 with an in-molded grommet 12 from the tool.

Preferably, a tool has a cavity within which the molded part is formed with a lid of the tool to form the backside of the part 10. The backside of a part 10 would typically have the grommet 12 to attach to a larger product. The lid closes to form a cavity is the shape of the desired part being molded. A mold release, such as a spray, wax-based compound, can initially be applied to the tool.

The lid of the tool may have a ball stud fastener that temporarily secures the grommet 12 in place within the tool. The rim 20 of the grommet 12 ideally is secured by the ball stud fastener sealed to the tool so that foam does not enter the tapered section 14 during molding. During extraction, the part 10 can be snapped off the reusable ball stud fastener on the tool with minimal or no foam in the tapered section 14 of the grommet 12.

As such, the grommet 12 is preferably inserted and secured in the tool with the rim 20 of the grommet 12 adjacent to the tool. This keeps foam from covering the tapered section 14 and ball stud receptacle 16 of the grommet 12 so tapered section 14 and ball stud receptacle 16 remain uncoated by foam in the final part 10. The edge 18 of the part 10 preferably aligns with the rim 20 of the grommet 12 to form a planar section around the tapered section 14.

The grommet 12 and the lid of the tool may be tilted, preferably between 2 and 10 degrees, such as at 5 degrees, to properly vent air that otherwise may be trapped in the tool. One side of the grommet 12 being higher than the other side allows air to vent during the molding process. Trapped air in molding may adversely affect the final part 10.

With the grommet 12 attached to the tool, the tool can close forming a cavity, and foam is then dispensed into the cavity of the tool to fill the cavity in the shape of the part 10. The foam is allowed to expand in the tool cavity and to cure. The foam will expand into the space between the flange 22 and outer wall 26 of the grommet 12, which will permit the cured foam to firmly secure the grommet 12 in place within the part 10.

The foam for an engine cover example is preferably medium density polyurethane with a density of 5-13 PCF (80-208 kg/m³).

The tool is opened and a part 10 with an in-molded grommet 12 can be extracted. If the ball stud receptacle 16 of the grommet 12 is secured by a fastener on a lid of the tool, the part 10 can be unsnapped from the fastener of the lid. The resulting part 10 is preferably a single, integral piece with the in-molded grommet 12 completely surrounded by cured foam except for the tapered section 14 and any ball stud receptacle 16 and possibly the rim 20.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

What is claimed is:

1. A foam part comprising;
a core of cured foam; and
a grommet with a flange opposite a rim, wherein the flange is surrounded by the core and the rim is not covered by the cured foam.

2. The foam part of claim 1 wherein the part is a single piece.

3. The foam part of claim 1 wherein the foam is polyurethane.

4. The foam part of claim 1 wherein the core includes polyurethane with a density of 5-13 PCF.

5. The foam part of claim 1 wherein the foam part is an engine cover.

6. The foam part of claim 1 wherein the grommet is a ball stud anchoring grommet with a tapered section within the rim and a ball stud receptacle at a bottom of the tapered section, which are not covered by foam.

7. The foam part of claim 1 wherein a tapered section inside the rim of the grommet does not have a foam coating and an edge of the part is aligned with and secured to the rim of the grommet.

8. A foam engine cover for an engine comprising:
a core of foam; and
a grommet with a flange on a base opposite a rim, wherein the flange and the base are surrounded by the core, and a tapered section adjacent to the rim of the grommet is not covered by the foam;
wherein the engine cover with the grommet is an integral piece.

9. The engine cover of claim 8 wherein the grommet s a ball stud anchoring grommet.

10. A process of making in a tool a part including an in-molded grommet including steps of:
inserting into the tool the grommet with a flange on a base and a rim with an adjacent tapered section;
dispensing foam into the tool;
allowing the foam to expand in a tool cavity around the base and the flange of the grommet and to cure; and
extracting from the tool the part with the in-molded grommet with the tapered section substantially uncoated by foam.

11. The process of claim 10 wherein the tool and the grommet are tilted during the molding process between two and ten degrees with a tip of the grommet up.

12. The process of claim 10 wherein the tool has a ball stud fastener, the process comprising a further step of securing the grommet in place on the tool on the ball stud fastener before dispensing foam into the tool.

13. The process of claim 12 wherein the rim of the grommet is secured by the ball stud fastener sealed to the tool to keep foam from covering the tapered section.

14. The process of claim 12 wherein the extracting step includes the part being snapped off the ball stud fastener.

15. The process of claim 10 wherein the foam is polyurethane with a density of 5-13 PCF.

16. The process of claim 10 wherein the part is a single, integral piece.
